(19) United States
(12) Patent Application Publication
(10) Pub. No.: US 2026/0049012 A1
(43) Pub. Date: Feb. 19, 2026

(54) AUTOMATED RAINFALL FLOCCULANT DISBURSEMENT STRUCTURE FOR SEDIMENT AND EROSION CONTROL

(71) Applicant: Ethan A. Brodnick, Raleigh, NC (US)

(72) Inventor: Ethan A. Brodnick, Raleigh, NC (US)

(21) Appl. No.: 18/806,853

(22) Filed: Aug. 16, 2024

(51) Int. Cl. C02F 1/68; C02F 1/52; C02F 103/00; E02B 3/02

(52) U.S. Cl. CPC C02F 1/687; C02F 1/5209; E02B 3/023; C02F 2103/001; C02F 2201/006; C02F 2201/009; C02F 2209/005; C02F 2303/14

(57) ABSTRACT

An automated rainfall flocculant disbursement tower for sediment and erosion control, including a structure to support a waterproof hopper and a rainfall collector to collect rainfall prior to its entry into a collection facility. A sensor array detects the presence of the rainwater in the rainfall collector and emits an output signal to initiate the operation of a disbursement wheel/mechanism powered by a distribution motor to disperse a flocculant into the rainwater runoff. A cartridge is provided including a housing to contain operational components of a flocculant emission system which stores and disperses the flocculant such that the flocculant is emitted from the internal cartridge and dosing sleeve via the operation of the distribution motor and wheel/mechanism.

### TECHNICAL FIELD

The embodiments disclosed herein generally relate to chemical applicators and more specifically to a rainfall flocculant disbursement tower for sediment and erosion control.

### BACKGROUND

Flocculation is a process of contact and adhesion wherein the particles of a dispersion form larger-size cluster. Flocculation is widely employed in water treatment purification as well as sewage treatment, storm-water treatment and treatment of industrial wastewater streams. In the construction industry, flocculants (i.e., polyacrylamide (PAM)) are included in sediment and erosion control but the application and timing of their use is limited to pre-storm events and is typically done by hand labor or inclusive to seeding operations or impregnated waddles or in the form of a block added to a pipe inlet/outlet.

A variety of flocculants have been implemented in the flocculation process, with each having benefits suitable for various applications and environments. Effective implementation of flocculants in construction sites is possible through proper dosage, dosage delivery mechanisms, and application. Examples of common flocculants include Chitosan, PAM, Polyaluminum Chloride (PAC), Diallyl dimethyl ammonium chloride (DADMAC), Calcium sulfate (Gypsum), Aluminum Sulfate (Alum), Aluminum chlorhydroxide, Natural starch, and Mimosa bark. Each flocculant has unique benefits and drawbacks. Further, each flocculant requires specific dosing protocols to ensure efficacy in each particular application.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an automated rainfall flocculant disbursement tower for sediment and erosion control, including a structure to support a waterproof hopper and a rainfall collector to collect rainfall prior to its entry into a collection facility. A sensor array detects the presence of the rainwater in the rainfall collector and emits an output signal to initiate the operation of a disbursement wheel powered by a distribution motor to disperse a flocculant into the rainwater runoff. A cartridge is provided including a housing to contain operational components of a flocculant emission system which stores and disperses the flocculant such that the flocculant is emitted from the internal cartridge and dosing sleeve via the operation of the distribution motor, wheel or mechanism.

In the current industry, flocculants are utilized in sediment and erosion control. However, their application and timing of their use is limited to pre-storm events and typically manually operated or used in seeding operations, impregnated waddles, or in the form of a block added to a pipe inlet/outlet. The embodiments described herein is configured to distribute flocculants at a prescribed rate near the sediment and/or erosion control treatment basin. The hopper is configured to distribute the flocculants pre-storm, during a storm, or post-storm to increase contact time and improve water quality or clarity.

In one aspect, the cartridge includes an internal cartridge and a dosing sleeve, wherein the internal cartridge stores the flocculant within the dosing sleeve.

In one aspect, the structure is a suspended arch tower positioned at a predetermined location to collect rainfall. However, the structure may be any construction which suspends the arch over the location of flocculant distribution where rainfall and/or stormwater runoff is located.

In one aspect, the sensor array is positioned on the cartridge. The sensor array may also be positioned at a remote location in reference to the cartridge such that the sensor array may detect precipitation upstream or at another location which is not at the precise location of the cartridge. In one aspect, a solar panel provides power to a power storage device.

In one aspect, the power storage device is in electrical communication with the distribution motor to turn the disbursement wheel, or mechanism/device.

In one aspect, the sensor array is operable to sense the presence of moisture indicative of rainfall, stormwater runoff, and effluent, wherein the sensor array to emit the output signal to a microcontroller to initiate the emission of the flocculant.

In one aspect, the microcontroller is in operable communication with a memory configured to store operational instruction to emit a pre-specified amount of the flocculant, wherein the pre-specified amount of the flocculant is dependent on a flocculant classification and a moisture value sensed by the sensor array.

In one aspect, the flocculant is a sediment control reactive agent.

In one aspect, an on/off indicator to emit an indicator light or signal to indicate the operational status of the cartridge.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a schematic of the cartridge for the automated disbursement of the flocculant for sediment and erosion control, according to some embodiments; and

FIG. 2 illustrates the cartridge mounted to a structure to automatically disburse flocculant for sediment and erosion control, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an automated rainfall flocculant disbursement tower for sediment and erosion control. The system includes a structure (e.g., a suspension tower, arch tower, waterproof hopper/canister, rainfall collector, rainfall sensor, distribution motor and wheel/mechanism internal cartridge and dosing sleeve, maintenance hatch, full/empty dial, battery compartment, solar panel and ON/OFF indicator.

Presently, in the Construction Industry Flocculants (i.e., PAM) is included in Sediment & Erosion Control but the application and timing of their use is limited to pre-storm event and is typically done by hand labor, or inclusive to seeding operations or impregnated Waddles or in the form of a block added to a pipe inlet/outlet. The Design/Device concept described herein distributes flocculants at a prescribed rate/design close to the Sediment & Erosion Control Treatment Basin Pre-Storm/During Storm/or Post Storm During Runoff Produced conditions. Contact time and distribution is increased and Water Quality and/or clarity improved.

During use, the device is preloaded with the Flocculant/Pam as provided or per site conditions. The Device (R.A.F.T.) is suspended on an arched suspension system at a prescribed location either by a contractor or engineered drawings. The Device is setup such that certain rainfall intensity/qty or conditions trigger the automated disbursement wheel/mechanism to disperse the material in a broadcasted fashion into the stormwater runoff or effluent of any type before it enters the Sediment & Erosion Control Collection Facility. The treated stormwater/effluent is dosed such that increased sediment is dropped out of suspension on the site.

In such, the device provides rainfall automation for dosing during non-business hours. The cartridge dosing system delivers proper quantities and dosage for each rain event. The proprietary cartridge system can be regulated and monitored by operators. This system enables maximum effectiveness with dosing at or near the discharge point and during unmonitored hours. Further, the system reduces waste of the flocculant which is currently cost-prohibitive and reduces its use in the current industry.

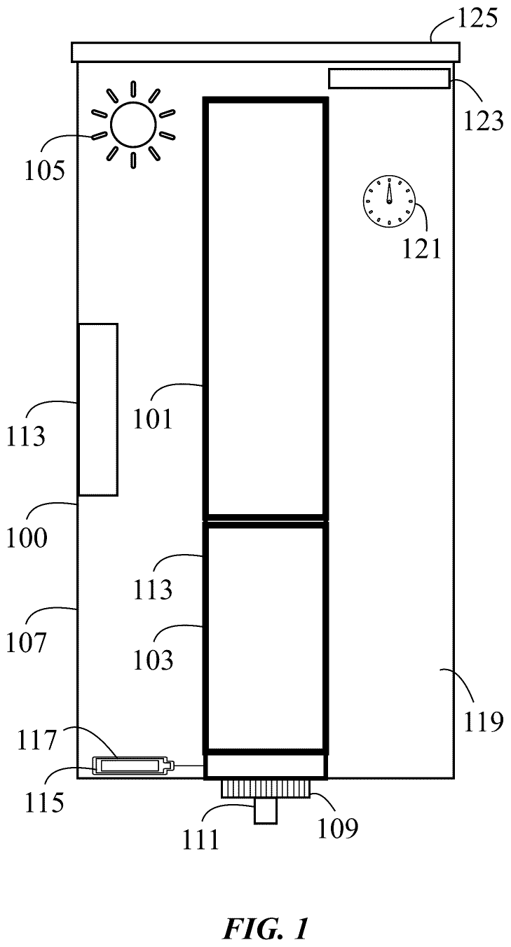

FIG. 1 illustrates a schematic of the cartridge 100 used for the automatic disbursement of flocculant for sediment and erosion control. The cartridge 100 is preloaded with flocculant which is stored within an internal cartridge 101 including a dosing sleeve 103. A sensor array 105 is positioned on the housing 107 of the cartridge 100 or at a nearby location such that the sensor array 105 may detect rainfall in the near vicinity. If rainfall is detected, the automated system initiates the disbursement of flocculant via a distribution motor 109 and disbursement wheel/mechanism 111. The housing 107 may also include a solar cell 113 which provides power to a battery 115 stored within a battery compartment 117 in the interior 119 of the housing 107. A full/empty dial 121 or other indicator is capable of displaying the flocculant level contained within the internal cartridge 101 and dosing sleeve 103. An ON/OFF indicator 123 or similar status indicator is capable of displaying the operational status of the cartridge 100. The housing 107 may also include a maintenance hatch 125 which enables an operator to open and close the cartridge 100 to add flocculant or otherwise perform maintenance to the components of the cartridge 100.

In some embodiments, the sensor array 105 may include various means of detecting rainwater, or similar weather conditions which product rainwater, storm runoff or other moisture which can require the treatment of runoff from a precipitation event. For example, the sensor array 105 may include moisture sensors, a rainwater collector (such as to measure the amount of precipitation which has accumulated), etc.

In some embodiments, the sensor array 105 may be capable of determining the amount of rainwater which has accumulated, or the amount of runoff being produced in an environment. Once a threshold value is reached, the sensor array 105 provides instructions to emit an amount of flocculant to effectively treat the stormwater runoff.

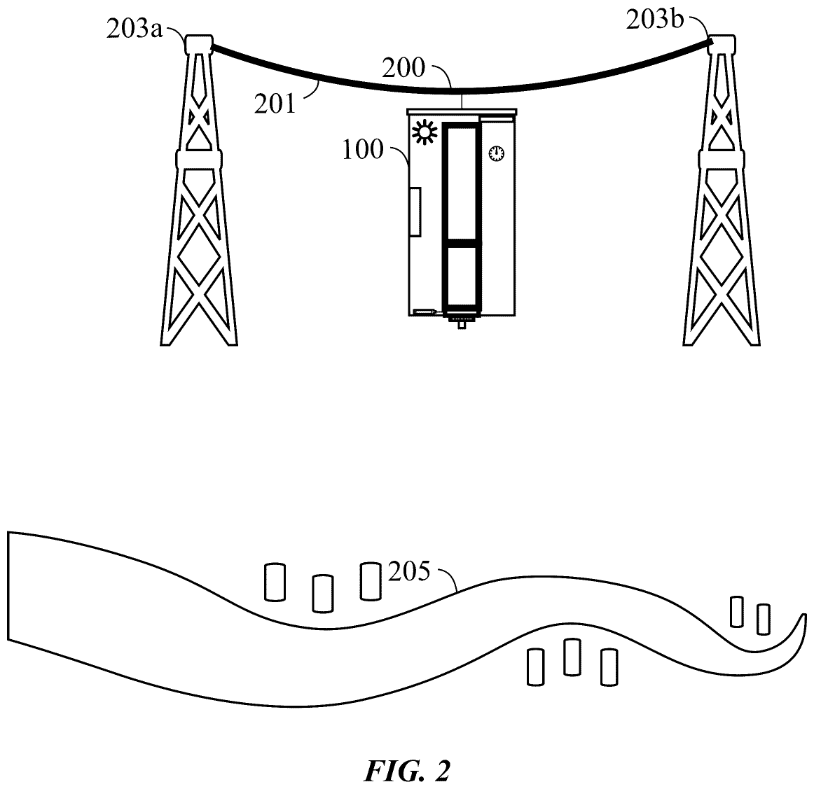

FIG. 2 illustrates an exemplary structure 200 from which the cartridge 100 is suspended. It is to be understood that the structure may take various forms. One skilled in the arts will readily understand that while the illustrated embodiment shows a suspended wire 201 between towers 203a,203b, various means of suspending the cartridge 100 above a treatment basin 205 may be implemented. The structure 200 may enable the cartridge 100 to distribute flocculant prior to a storm, during a storm, or after a storm to effectively treat storm water runoff to improve the water quality and/or clarity of the stormwater runoff.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An automated rainfall flocculant disbursement tower for sediment and erosion control, the system comprising:
a structure to support a waterproof hopper;
rainfall collector to collect rainfall prior to its entry into a collection facility;
a sensor array to detect the presence of the rainwater in the rainfall collector and to emit an output signal to initiate the operation of a disbursement wheel powered by a distribution motor to disperse a flocculant into the rainwater runoff; and
a cartridge comprising a housing to contain operational components of a flocculant emission system, the flocculant emission system to store and disperse the flocculant, wherein the flocculant is emitted from the internal cartridge and dosing sleeve via the operation of the distribution motor and wheel mechanism.

2. The automated rainfall flocculant disbursement tower for sediment and erosion control of claim 1, wherein the cartridge includes an internal cartridge and a dosing sleeve, wherein the internal cartridge stores the flocculant within the dosing sleeve.

3. The automated rainfall flocculant disbursement tower for sediment and erosion control of claim 1, wherein the structure is a suspended arch tower positioned at a predetermined location to collect rainfall.

4. The automated rainfall flocculant disbursement tower for sediment and erosion control of claim 1, wherein the sensor array is positioned on the internal cartridge.

5. The automated rainfall flocculant disbursement tower for sediment and erosion control of claim 1, further comprising a solar panel to provide power to a power storage device.

6. The automated rainfall flocculant disbursement tower for sediment and erosion control of claim 5, wherein the power storage device is in electrical communication with the distribution motor to turn the disbursement wheel mechanism.

7. The automated rainfall flocculant disbursement tower for sediment and erosion control of claim 1, wherein the sensor array is operable to sense the presence of moisture indicative of rainfall, stormwater runoff, and effluent, wherein the sensor array to emit the output signal to a microcontroller to initiate the emission of the flocculant.

8. The automated rainfall flocculant disbursement tower for sediment and erosion control of claim 7, wherein the microcontroller is in operable communication with a memory configured to store operational instruction to emit a pre-specified amount of the flocculant, wherein the pre-specified amount of the flocculant is dependent on a flocculant classification and a moisture value sensed by the sensor array.

9. The automated rainfall flocculant disbursement tower for sediment and erosion control of claim 1, wherein the flocculant is a sediment control reactive agent.

10. The automated rainfall flocculant disbursement tower for sediment and erosion control of claim 1, further comprising an on/off indicator to emit an indicator light or signal to indicate the operational status of the cartridge.

11. An automated rainfall flocculant disbursement tower for sediment and erosion control, the system comprising:
a suspension tower to support a waterproof hopper, the waterproof hopper including a rainfall collector to collect rainfall;
a sensor array to detect the presence of the rainwater in the rainfall collector and to emit an output signal to initiate the operation of a disbursement wheel mechanism powered by a distribution motor to disperse a flocculant into the rainwater runoff;
a cartridge comprising a housing to contain operational components of a flocculant emission system, the flocculant emission system to store and disperse the flocculant, wherein the flocculant is emitted from the internal cartridge and dosing sleeve via the operation of the distribution motor and wheel mechanism; and
a microcontroller in operable communication with the cartridge to receive a signal from the sensor array and to initiate an operational sequence of the distribution motor and wheel mechanism, wherein the microcontroller is operable to selectively release a pre-specified amount of the flocculant into the runoff to treat the runoff prior to its entry into a collection facility.

12. The automated rainfall flocculant disbursement tower for sediment and erosion control of claim 11, wherein the cartridge includes an internal cartridge and a dosing sleeve, wherein the internal cartridge stores the flocculant within the dosing sleeve.

13. The automated rainfall flocculant disbursement tower for sediment and erosion control of claim 11, wherein the sensor array is positioned on the internal cartridge.

14. The automated rainfall flocculant disbursement tower for sediment and erosion control of claim 11, further comprising a solar panel to provide power to a power storage device.

15. The automated rainfall flocculant disbursement tower for sediment and erosion control of claim 15, wherein the power storage device is in electrical communication with the distribution motor to turn the disbursement wheel mechanism.

16. The automated rainfall flocculant disbursement tower for sediment and erosion control of claim 11, wherein the sensor array is operable to sense the presence of moisture indicative of rainfall, stormwater runoff, and effluent.

17. The automated rainfall flocculant disbursement tower for sediment and erosion control of claim 17, wherein the microcontroller is in operable communication with a memory configured to store operational instruction to emit a pre-specified amount of the flocculant, wherein the pre-specified amount of the flocculant is dependent on a flocculant classification and a moisture value sensed by the sensor array.

18. The automated rainfall flocculant disbursement tower for sediment and erosion control of claim 11, wherein the flocculant is a sediment control reactive agent.

19. The automated rainfall flocculant disbursement tower for sediment and erosion control of claim 11, further comprising a cartridge dosing maintenance hatch on the housing of the cartridge.

20. The automated rainfall flocculant disbursement tower for sediment and erosion control of claim 21, further comprising a dial to display a real-time amount of flocculant within the cartridge, and wherein the cartridge dosing maintenance hatch enables an operator to refill or replace the flocculant or the internal cartridge containing the flocculant.
